(19) United States
(12) Patent Application Publication
(10) Pub. No.: US 2017/0310807 A1
(43) Pub. Date: Oct. 26, 2017

(54) VERTICAL SLIDE APARATUS WITH ROTATIONAL SCREEN FOR SMART PHONES, PDAS, TABLETS AND THE LIKE

(71) Applicant: Harold P. Mintz, Fort Lee, NJ (US)

(72) Inventor: Harold P. Mintz, Fort Lee, NJ (US)

(21) Appl. No.: 15/137,215

(22) Filed: Apr. 25, 2016

(51) Int. Cl. H04M 1/725

(52) U.S. Cl. CPC H04M 1/72519

(57) ABSTRACT

A smart phone including a body layer of a smart phone that houses a physical QWERTY keyboard; and a touchscreen layer of the smart phone housing a touchscreen and configured above the body layer. The touchscreen layer slides over the body layer to reveal the physical QWERTY keyboard. The touchscreen layer then rotates over the body layer to form a T-shape with the body layer to allow viewing of and interacting with content in a widescreen format on the touchscreen, while also allowing use of the physical QWERTY keyboard.

### BACKGROUND OF THE INVENTION

### Field of the Invention

The present invention generally relates to smart phones, personal digital assistants, phablets (i.e., small-sized phone/tablets), and the like (all hereafter grouped and referred to as “smart phone”), and more particularly to a smart phone design where the screen can slide vertically to reveal a physical QWERTY keyboard and then optionally rotate for a superior visual experience.

### Discussion of the Background

Over the years, functionality of smart phones (e.g., including mobile phones, personal digital assistants, tablets, phablets (phone/tablets), etc.) and their screens and keyboards is extensive. However, previous designs are not robust with respect to touch screens, keyboards, and rotational, and the like, designs thereof.

### SUMMARY OF THE INVENTION

The above and other problems with conventional smart phones (e.g., including mobile phones, personal digital assistants, tablets, phablets (phone/tablets), etc.) and their screen and keyboard designs are addressed by the present invention, which provides smart phone designs, for example, wherein the touch screen can (i) vertically slide to reveal a physical QWERTY keyboard; and (ii) then optionally rotate to take advantage of, for example, a 16:9 aspect ratio in which video content typically is presented. The slide and optional rotation design combination provides various advantages, and overcomes various issues with conventional designs, particularly for users that prefer a physical QWERTY keyboard. For example, most smart phone designs have completely abandoned the use of physical QWERTY keyboards, as they monopolize space, and because serious writing is now less important than is 5-word text messages with an emoji, and the like. Moreover, with the increasing emergence of video as a preferred mode of entertainment, touchscreen-only screen designs have become popular, with market preference for touchscreen-only devices that incorporate a virtual, touchscreen keyboard, mimicking a real physical keyboard. Such designs have been driven and advanced by market-leaders such as iPhone, Galaxy, HTC, etc., and adopted and patterned after by the other participants. However, for some users, a physical QWERTY keyboard remains an essential and highly desired feature. Accordingly, the present invention includes recognition of the above and other problems with conventional designs, and recognizes that many users still prefer a physical QWERTY keyboard, but would also like the benefit of the widescreen format for video content, and the like, as well as for document reading, creation, and editing. For example, turning a vertically-oriented smart phone horizontally to view video in widescreen makes the phone cumbersome to hold. Moreover, many videos will not conform and turn horizontally when you turn the phone, so a user is often forced to view the video either in “letterboxed” mode or cropped out side-to-side in the vertical position—both of which provide a far less pleasurable viewing experience for a user. Similarly, turning a smart phone with a physical QWERTY keyboard horizontally, typically, does not allow a user to employ the keyboard properly, and in the case of a slider type design, not only can a user not use the physical keyboard properly, but also the device must have added length and size in such application. The present invention allows the smart phone to be held more comfortably in the palm of the hand, and worked with in the classic vertical position, but with the screen in widescreen (e.g., “landscape”) format, and the like, advantageously, allowing videos to be more comfortably watched, and documents to be more comfortably read, and the like.

Accordingly, in illustrative aspects of the present invention there is provided a smart phone including a body layer of a smart phone that houses a physical QWERTY keyboard; and a touchscreen layer of the smart phone housing a touchscreen and configured above the body layer. The touchscreen layer slides over the body layer to reveal the physical QWERTY keyboard. The touchscreen layer then rotates over the body layer to form a T-shape with the body layer to allow viewing of and interacting with content in a widescreen format on the touchscreen, while also allowing use of the physical QWERTY keyboard.

The rotated touchscreen can click downward into a locked position. The sliding and rotating touchscreen includes a trackpad and buttons. The sliding and rotating touchscreen is configured as an infinity screen. When the touchscreen is not slid and not rotated, the smart phone appears and functions as a touchscreen-only smart phone.

Still other aspects, features, and advantages of the present invention are readily apparent from the following detailed description, simply by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 shows a front view of an illustrative smart phone with the screen not vertically slid to reveal the physical QWERTY keyboard;

FIG. 2 shows a back view of an illustrative smart phone with the physical keyboard not yet exposed;

FIGS. 3-4 show a front and back view of another illustrative smart phone with the physical keyboard not exposed;

FIGS. 5-6 show a front and back view of another illustrative smart phone where the touchscreen layer is larger than the body layer with the physical keyboard not yet exposed;

FIGS. 7-8 show two other conceptual back views of other illustrative smart phones where the touchscreen layer is larger and has a different shape than the body layer with the physical QWERTY keyboard not yet exposed;

FIGS. 9-10 show a right and left side view of the illustrative smart phone shown in FIGS. 1-2 with the screen not extended;

FIG. 11 shows a front view of an illustrative smart phone with the touchscreen screen vertically extended;

FIG. 12 shows a rear view of the illustrative smart phone in FIG. 11;

FIG. 13 shows a front view of an illustrative smart phone with the touchscreen screen vertically extended;

FIG. 14 shows a rear view of the illustrative smart phone in FIG. 13;

FIG. 15 shows a front view of another illustrative smart phone with the touchscreen extended;

FIG. 16 shows the rear view of the phone shown in FIG. 15;

FIGS. 17-18 show right and left side views of an illustrative smart phone as shown in FIGS. 11-16;

FIG. 19 shows a front view of an illustrative smart phone as shown in FIG. 1 with the touchscreen both vertically slid to reveal the physical QWERTY keyboard and then rotated 90 degrees;

FIG. 20 shows another front view of an illustrative smart phone as shown in FIG. 1 with the touch screen extended and rotated revealing an extra set of buttons and track pad;

FIG. 21 shows another front view example of an illustrative smart phone as shown in FIG. 1 with the touchscreen keyboard both vertically slid to reveal the physical QWERTY keyboard and then rotated 90 degrees revealing a second track pad;

FIG. 22 shows another front view of an illustrative smart phone as shown in FIG. 3 with the touchscreen keyboard both vertically slid to reveal the physical QWERTY keyboard and then rotated 90 degrees;

FIG. 23 shows another front view of an illustrative smart phone as shown in FIG. 3 with the touchscreen keyboard both vertically slid to reveal the physical QWERTY keyboard and then rotated;

FIG. 24 shows a rear view of the illustrative embodiment of the smart phone shown in FIGS. 19-23 where the touchscreen keyboard has been both vertically slid to reveal the physical QWERTY keyboard and then rotated to take advantage of the widescreen format so that the entire device resembles the letter “T”;

FIGS. 25-26 show right and left side views of an illustrative smart phone as shown in FIGS. 19-23;

FIG. 27 shows the same embodiment as shown in FIG. 19, but highlighting the position before the click down into place option as shown in FIG. 28;

FIG. 29 shows the rotated widescreen embodiment of FIGS. 22-23 clicked downward after 90-degree rotation for a slightly more compact experience;

FIG. 30 shows the rotated widescreen embodiment of FIG. 19 clicked downward after rotation for a slightly more compact experience where a track pad and other buttons are accessible in addition to the physical QWERTY keyboard;

FIG. 31 shows a rear view of the embodiment shown in FIGS. 28-30 where the touchscreen keyboard has been vertically extended, 90-degrees rotated, and then clicked downward for a more compact experience;

FIGS. 32-33 show a right and left side view of the embodiment shown in FIGS. 28-30;

FIG. 34 shows the conceptual innards from a back view of an illustrative embodiment as the touchscreen 102 is extended;

FIG. 35 shows the conceptual innards from a back view of an illustrative embodiment as the touchscreen 102 is extended and then rotated 90 degrees;

FIG. 36 shows the conceptual innards from a back view of the touchscreen 102 optionally clicked down after rotation;

FIG. 37 shows a back view of a hand comfortably holding an illustrative smart phone in the palm with the touchscreen extended and rotated; and

FIG. 38 shows a back view of a hand comfortably holding an illustrative smart phone as illustrated in FIG. 32 in the palm with the touchscreen 102 now clicked downward into place.

### DETAILED DESCRIPTION OF THE PREFERRED EMBODIMENTS

A smart phone (e.g., including mobile phones, personal digital assistants, tablets, phablets (phone/tablets), etc.) with a physical QWERTY keyboard may seem to be from a bygone era; however, for many, the physical keyboard remains a vitally essential feature. The reasons for preferring a physical keyboard are myriad from the simple—not liking to continually smudge the screen with oily fingers—to the sublime—a tactile thought provoking correlation where writers think while typing and experience the keys the same way a pianist thinks while tickling the ivories. Therefore, there is a need for a new paradigm of smart phone that incorporates a design, whereby the touchscreen slides vertically upward to reveal a physical QWERTY keyboard underneath and then optionally rotates 90 degrees so that video images and documents can be viewed horizontally in the accepted widescreen format without having to turn the device in your hand.

Over the years, there are a variety of ways that a physical keyboard has been included in a smart phone: a small screen and a front keyboard (e.g., the Palm and the Blackberry Bold); a clam-shell/lap top-like design where the device folds horizontally and opens to reveal the keyboard (e.g. T-Mobile G1 and HTC Tilt); a vertical sliding reveal of a physical keyboard (e.g., Blackberry Torch and Priv); and a touchscreen that swivels open (e.g., T-Mobile G1 and HTC Touch HD). There has never been a design, as with the present invention, that incorporates a touchscreen that both optionally vertically slides to reveal a physical QWERTY keyboard and then has the additional ability to rotate 90 degrees so that it forms a “T” design with the main body of the smart phone with the revealed physical QWERTY keyboard included in the stem of the “T” and the rotated screen serving as the top of the “T”.

Advantageously, because of the present invention's versatility, when the screen is not slid vertically to reveal the physical keyboard—let alone rotated 90 degrees—the smart phone looks and acts as a touchscreen-only device, albeit a tad thicker due to the unexposed physical keyboard. Accordingly, the present invention allows those who have a strong preference for a physical keyboard to have the best of both worlds and more.

For example, when the smart phone screen is physically slid vertically to reveal the physical keyboard, the virtual keyboard is no longer activated. Otherwise, this would be far too confusing and convoluted a design, as well as take up too much screen real estate. The vertical sliding of the touchscreen to reveal the physic QWERTY keyboard, indicates a likelihood that typing will occur. Therefore, it is unnecessary to have the virtual keyboard on the touchscreen too. If a user wants to use the virtual touchscreen keyboard for whatever reason, they can slide the vertical screen back into place and use the device as if it were a touchscreen only device.

Years ago, computer monitors (as well as televisions) were basically square with a 4:3 aspect ratio. Today the de facto standard is a horizontal ‘widescreen’ 16:9 aspect ratio monitor, and the image quality is denoted by the number of pixels delivered in width×height. For example, “1366×768” means the width is 1366 pixels and the height is 768 pixels. A compelling attribute of the present invention is that after vertically sliding the screen to reveal the keyboard, the screen can be rotated. Advantageously, this allows for the combination of a physical keyboard and a horizontal ‘widescreen’ format, providing an advantage of a full laptop or a tablet that also utilizes a connected physical keyboard.

For many writers, the present invention is vastly superior, as it enables them to perform heavier duty writing and other work on their smart phone versus having to carry or travel with a separate lap top or tablet. With this invention, the ability to rotate the screen 90 degrees combining the widescreen, the physical QWERTY keyboard, and with a more comfortable fit in the palm design allows a user to see many more words on the screen at one time than with a vertical screen. This is a tremendous productivity boost versus having to read and/or edit on a much smaller ‘portrait’ vertical screen.

Comparisons to what has been available prior are striking. For example, some early smart phones tried a “clam shell” design, somewhat akin to a lap top. However, working with such a horizontal design was clunky at best and could not be done with one hand at all. Another contrast is with vertical slide-only smart phones, wherein there is the keyboard provided but the display is in portrait and not in sync with the desk top widescreen format (e.g., the Torch or Priv). Continuing the comparisons, smart-phones with a small screen and a physical keyboard (e.g., such as the Bold) do not allow a writer to experience the benefits of today's high-caliber, far larger touchscreens. The present invention allows an individual to perform efficient writing, as the user is able to hold the device vertically, yet see content horizontally, providing numerous advancements, for example, in terms of ergonomics, work productivity, and the like.

A clear trend is for ever larger smart phones, as they have larger screens that are better suited to view images and videos, and the like, and as present day society is increasingly driven by image and video content, and the like. For example, most high-end video is now shot, produced, and delivered in widescreen format. As the smart phone is increasingly being used to watch such video content, the present invention greatly facilitates the viewing of such videos, as well as the playing of computer games, and the like.

Many smart phones are designed with a horizontal screen necessitating the device be physically turned and held horizontally to get the full benefit of a widescreen format, and the like. However, it is very cumbersome to hold a smart phone in this horizontal position for any duration of time. In fact, most people have difficulty supporting a horizontal smart phone for even short periods of time—even those with large hands. When devices do not rest comfortably in the palm of the hand, fingers get tired, and horizontally-balanced devices get dropped. One of the legendary smart phone progenitors was called “The Palm”, accentuating a device that can ideally be held and supported in the palm of the hand. However, holding a longer smart phone horizontally, often requires two hands, is tiring on the fingers, which must grip it to secure it, and is not palm-friendly at all.

The stress of holding a vertically-oriented smart phone sideways has sought to be addressed by having stands built into proprietary smart phone cases and other types of creative stands being designed to prop the smart phone up, and the like. Many users utilize makeshift pillows and other items to support the screen for viewing. However, even with increasingly larger screens, smart phones are so much smaller than laptops and tablets that propping them up is rarely an adequate solution. For example, the ability to prop a smart cell phone up like a lap top or tablet is not nearly as good as being able to comfortably rest it in the palm of your hand and view it up close to a user's face rather than from further away. Moreover, there are many places where a smart phone can be enjoyed, but there is no viable or realistic option to prop it up, for example, including on a subway, in a bus, in a car, while standing in line, and the like. Advantageously, the present invention allows the device to be comfortably held/rested in the palm of the hand between the fingers and thumb, as the narrower end of the device rests in the palm of the hand. This allows users to comfortably use only one hand to hold the device, and to type with one hand, advantageous, in situations where the other hand is unavailable for whatever reason, while providing flexibility, increased productivity, superior ergonomic comfort, and an overall better user experience, and the like.

In this respect, the extended screen of the device of the present invention can be rotated horizontally essentially resting above the hand. With the screen so rotated (e.g., with the rotated screen serving as the top part of a “T”), the touchscreen itself functions as a pseudo brace directly above the curved thumb and the forefinger of the hand making it that much more comfortable to hold, particularly for long viewing durations, advantageous, when a user would like to relax, sit, or lie back, and watch a video on the device.

Another dilemma overcome by the present invention is that when widescreen video is viewed on a vertical screen, since it is not in sync with the widescreen format, the video presentation is altered. It can either be: (i) “letterboxed” which is a format for presenting movies on smart phones that maintains the rectangular theater image on the vertical screen by reducing the overall image until the full width can be seen, resulting in a very small image with blank, dark, horizontal spaces above and below the image; or (ii) the video is only presented in the middle of the full image with both sides essentially being cropped out and un-viewable outside of the vertical (e.g., non-widescreen) viewing area.

Most smart phones have tried to address such problems by allowing video to shift into widescreen format when the phone is physically turned sideways. However, this frequently does not work properly. Instead, sometimes, the video “refuses” to shift at all when the device is turned, leaving a user with a picture essentially sideways, and still in a vertical format. In other cases, the video may turn but remains letterboxed. Such problems, wherein widescreen video that could be viewed properly on a desktop computer or on a lap top are cropped out on a smart phone, even after turning it from the vertical to the horizontal, are very frustrating and negatively impact the viewing experience for a user.

Such limitation of vertically-oriented touchscreen only devices is causing a bit of an uproar for filmmakers. Current streaming media apps, led by companies such as Meerkat, Periscope, and Snapchat are subverting the oldest rule of filmmaking and forcing users to shoot vertically. While this is more comfortable for the long horizontal touchscreen smart phones, it is inconsistent with real cinematography. The present invention helps bridge such divide, as it provides a smart phone device, advantageously, configurable for widescreen viewing, and the like.

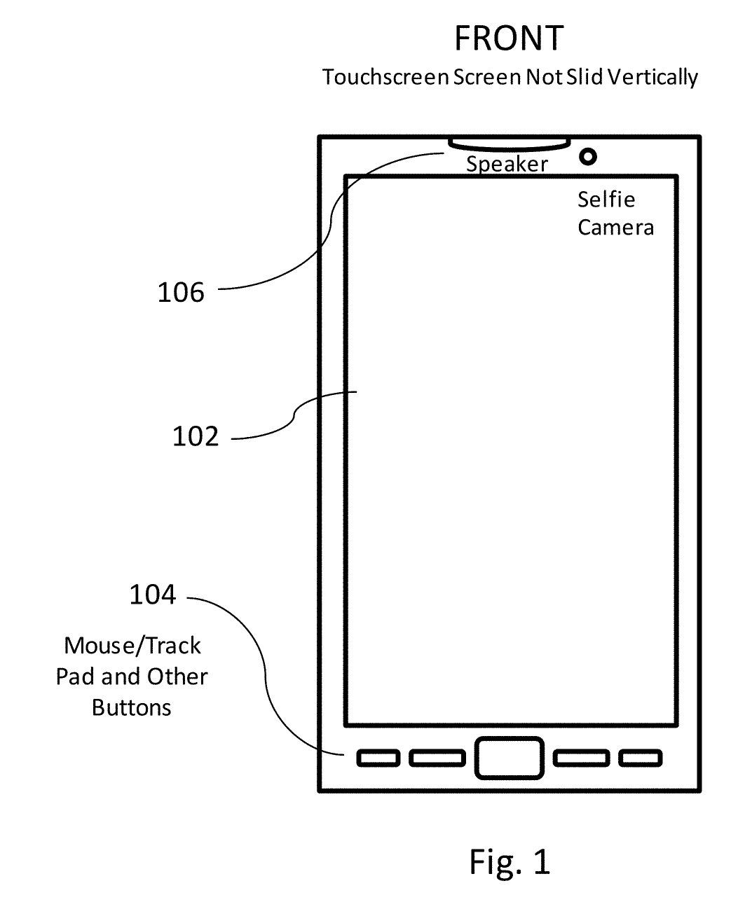

Referring now to the drawings, wherein like reference numerals designate identical or corresponding parts throughout the several views, and more particularly to FIG. 1 there is illustrated a front view of an illustrative smart phone with the touchscreen not yet vertically slid to reveal the physical QWERTY keyboard as well as not yet rotated, which will result in the entire device resembling the letter “T.” In this embodiment, the un-extended touchscreen 102 is accompanied by a row of physical control buttons and a mouse or track pad indicated by 104. The buttons and track pad 104 can be “virtual” in other embodiments and their functionality incorporated into the touchscreen 102. A front-facing audio speaker and a front-facing “selfie” camera are grouped together and shown as 106. All accoutrement from the speakers to selfie cameras to buttons and virtual buttons can be reorganized and repositioned, as will be appreciated by those of ordinary skill in the relevant art(s). In this position, the physical QWERTY keyboard and all of the slide and swivel benefits remain hidden and unused. Because of the current invention's versatility, when the screen is not slid vertically to reveal the physical keyboard, the smart phone looks and acts as a touchscreen-only device.

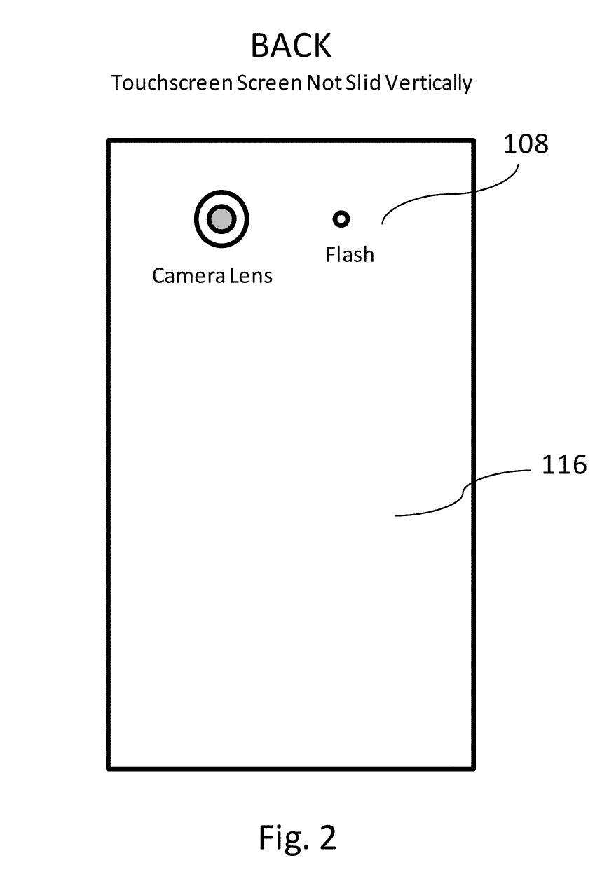

FIG. 2 shows a back view of an illustrative smart phone with the touchscreen not yet vertically slid to reveal the physical QWERTY keyboard, as well as not yet rotated, so that the entire device resembles the letter “T.” An illustrative outward-facing camera and flash are grouped together as 108. The main body of the smart phone that has the physical QWERTY keyboard and also houses the processor, the battery, the memory, and the like, is indicated by 116. Apart from the physical keyboard, all of such suitable items and functionality, including larger camera sensors, lenses, and optical zoom can be relocated and positioned within the touchscreen layer, including touchscreen 102 itself, as will be appreciated by those of ordinary skill in the relevant art(s).

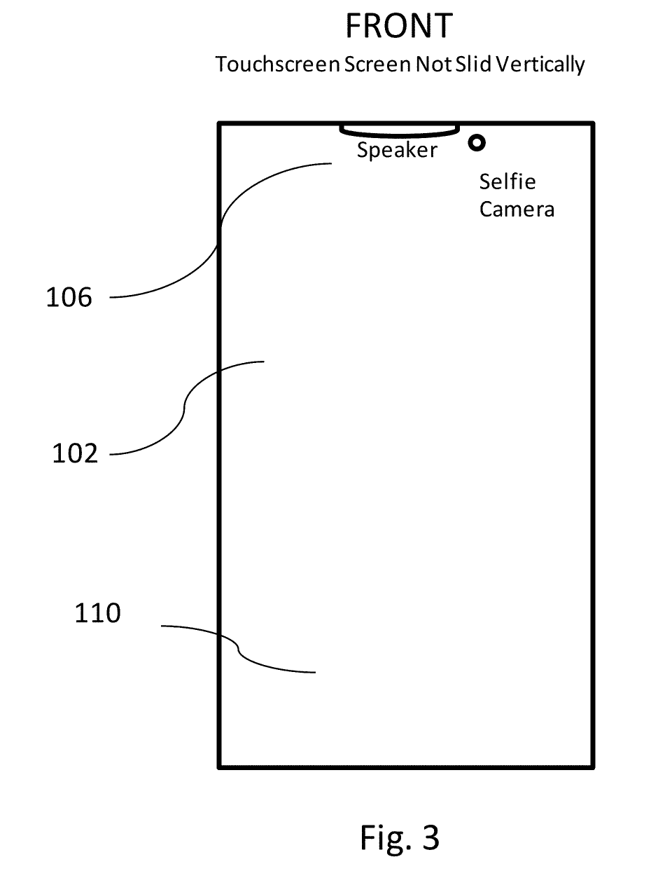

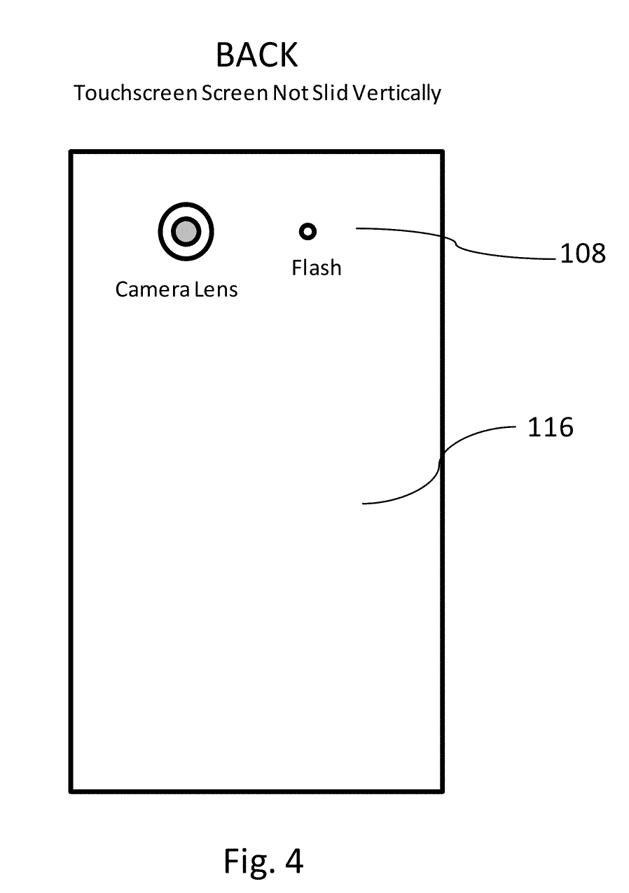

FIG. 3 shows a front view of another illustrative smart phone as introduced in FIGS. 1-2 with an “infinity” touchscreen 102 and no front-facing physical buttons or track pad of any sort, wherein the touchscreen is in the un-extended position. This embodiment is sleeker and more elegant. It also maximizes the touchscreen real estate by not taking up room with physical buttons or trackpads when the touchscreen is not slid vertically. Element 110 indicates a potential area for virtual buttons when the touchscreen is not yet vertically slid. In this position, the smart phone looks and acts just like a touchscreen only device, and the physical QWERTY keyboard and all of the slide and swivel benefits remain hidden and unused. FIG. 4 shows the back view of the illustrative smart phone of FIG. 3 which, for all intents and purposes, is the same as shown in FIG. 2.

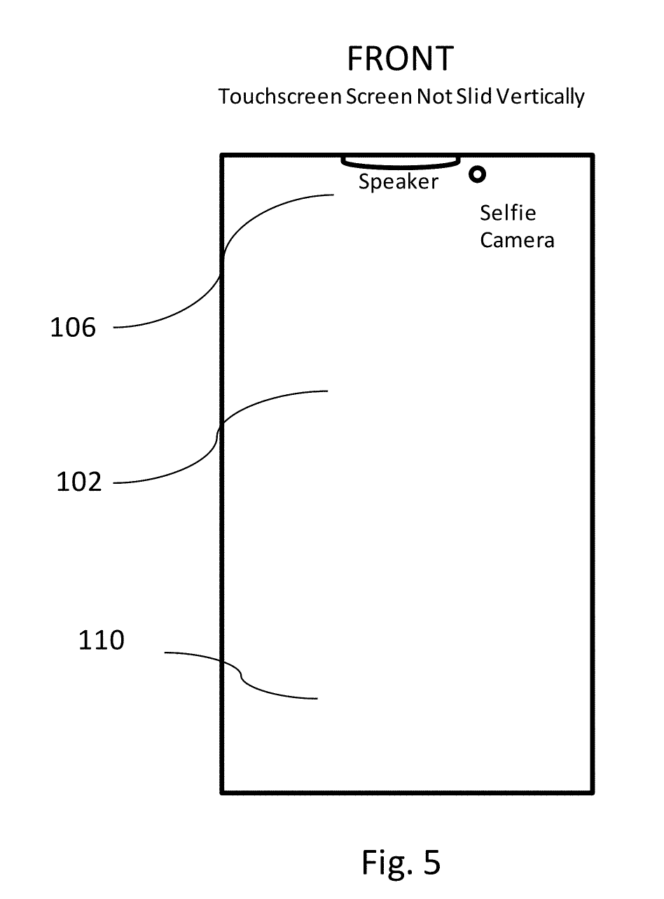

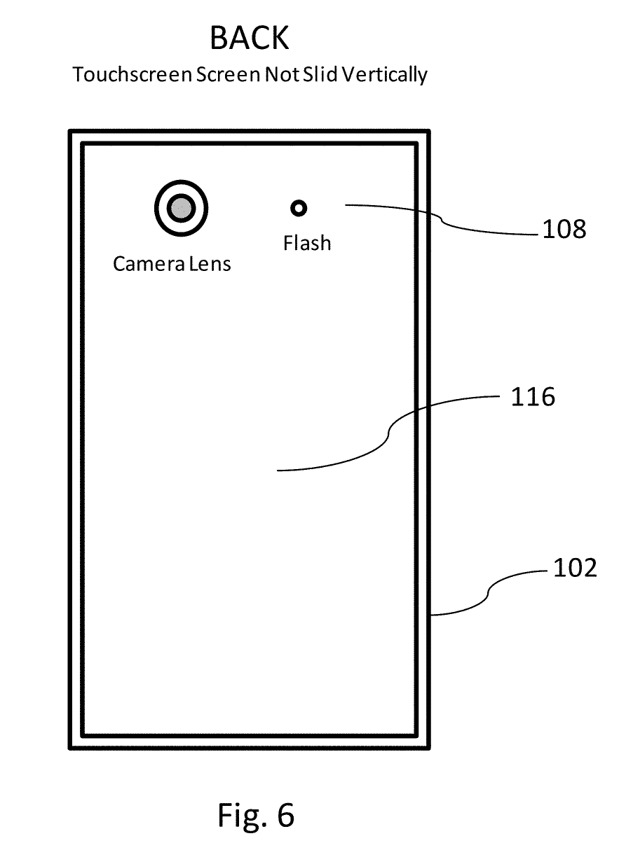

FIGS. 5-6 show a front and back of an illustrative smart phone much like that shown in FIGS. 3-4. However, one can see how the layer with the touchscreen 102 is larger than the body layer 116. Accordingly, in the back view, FIG. 6, edges of the touchscreen 102 extend past and overhang the body 116. This helps highlight that illustrative embodiments of the invention contemplate the touchscreen being larger and shaped differently than the body that houses the physical QWERTY keyboard.

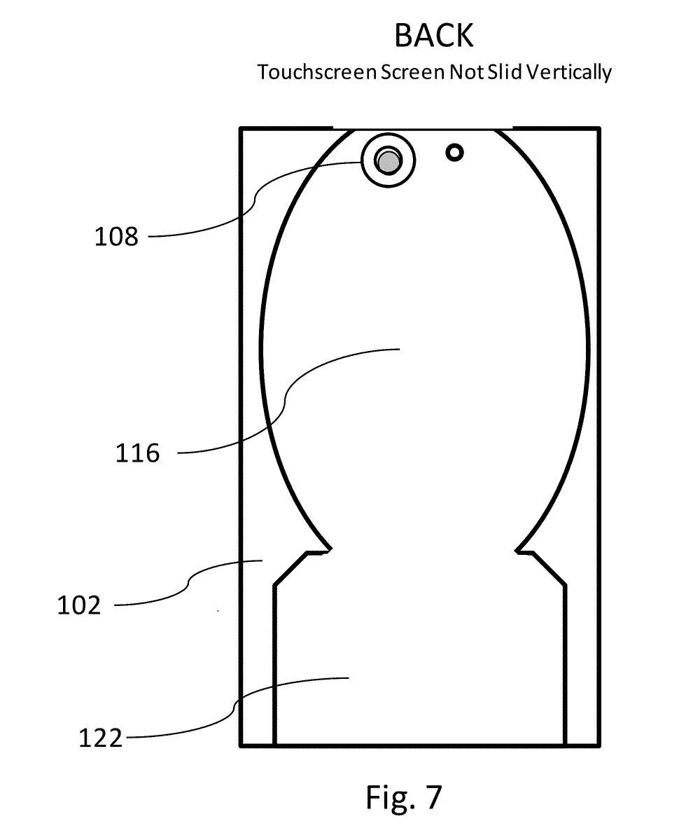

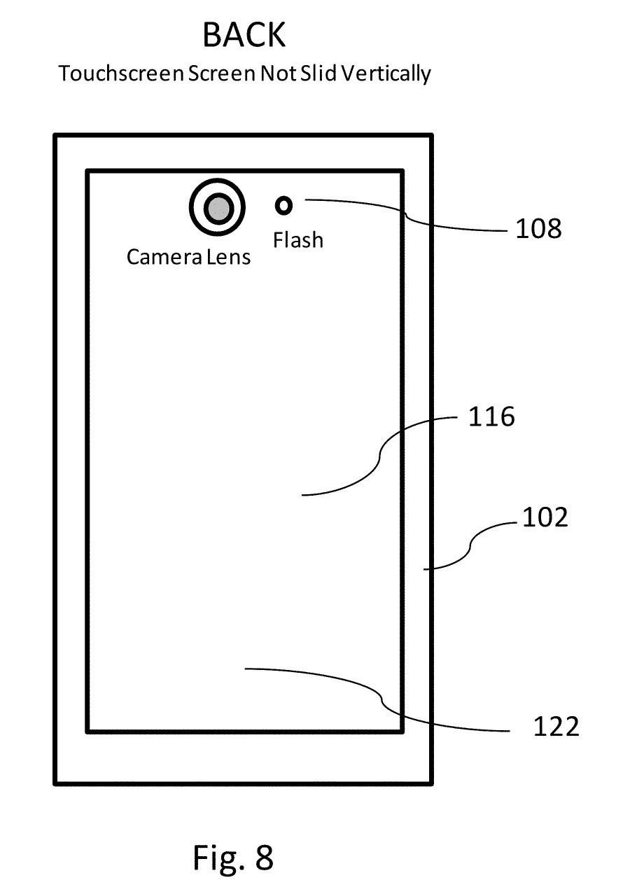

FIGS. 7-8 are further back views of an illustrative smart phone and show and highlight what is introduced in FIG. 6, that the horizontal touchscreen layer 102 can be larger and shaped differently than the back main body layer 116 that houses the physical QWERTY keyboard. The location of the physical QWERTY keyboard 122 is positionally-highlighted, though not visible in this back view. The device can have various size and shape variations of the body of the smart phone that houses the physical QWERTY keyboard 116, as will be appreciated by those of ordinary skill in the relevant art(s).

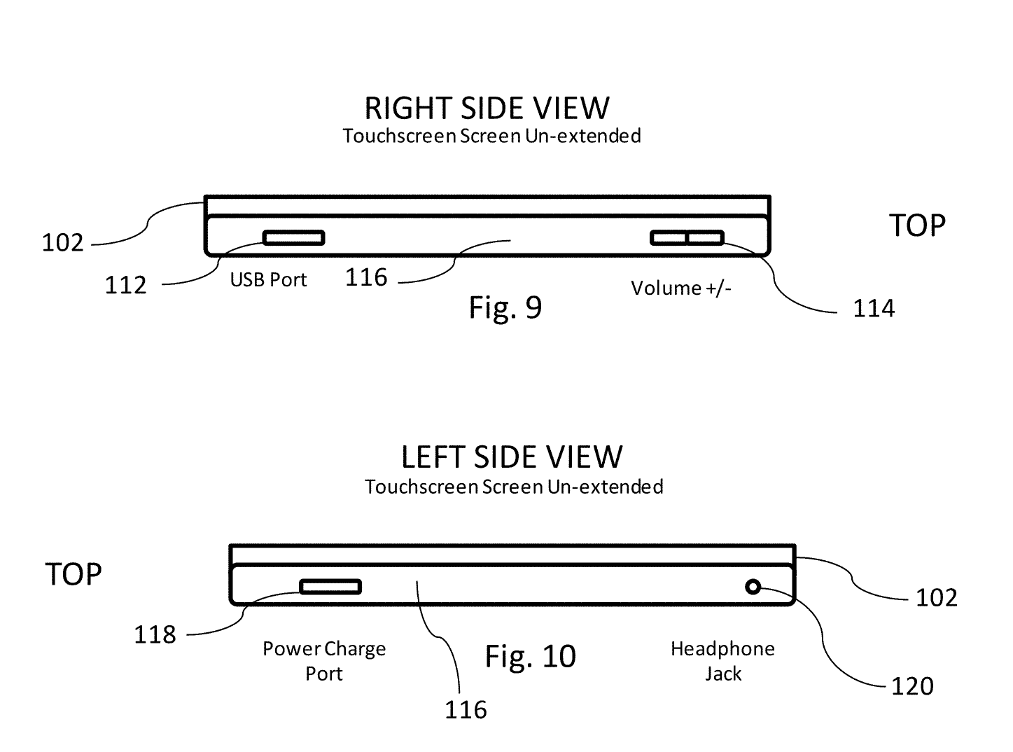

FIGS. 9-10 show a right side view and the left side view of the illustrative smart phone shown in FIGS. 1-4 with the touchscreen not yet vertically slid to reveal the physical QWERTY keyboard. The USB port 112 and volume control 114 are shown in FIG. 9. The power charge port 118 and the headphone jack 120 are shown in FIG. 10. Side buttons and other ports and controls are there for illustration only and can be included on the other side, the top or bottom of the illustrative smart phone, or elsewhere, as will be appreciated by those of ordinary skill in the relevant art(s). The side view reveals that the device in general can be thicker than a uni-body, touchscreen only, device as there are two layers—the touchscreen 102 layer and the physical QWERTY keyboard layer illustrated by 116. While it will contribute to some added thickness and weight, the device can also offer the opportunity to incorporate a larger battery and other features and enhancements as there is more space to work with because of the two layers.

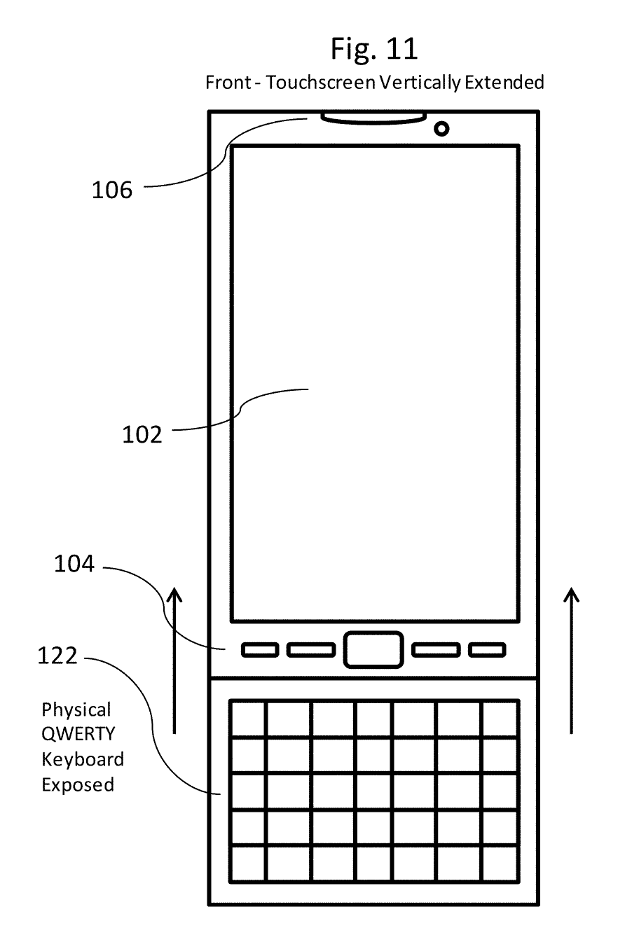

FIG. 11 shows a front view of an illustrative smart phone shown in FIGS. 1-2 with the touchscreen 102 and mouse/track pad and other buttons 104 vertically extended to reveal the physical QWERTY keyboard 122. When the screen is physically slid vertically to reveal the physical keyboard, the virtual keyboard is no longer activated. Otherwise, this would be far too confusing and convoluted a design, as well as take up too much screen real estate. By vertically sliding the screen to reveal the physical keyboard, a user is indicating that there is a likelihood that the user will be typing. Therefore, it is unnecessary to have the virtual keyboard on the touchscreen. If the user would prefer to use the virtual touchscreen keyboard for whatever reason—and not take advantage of the true physical QWERTY keyboard—the user can slide the vertical screen back into place and use the device as if it were a touchscreen only device. A front-facing audio speaker and a front-facing “selfie” camera are grouped together and shown as 106.

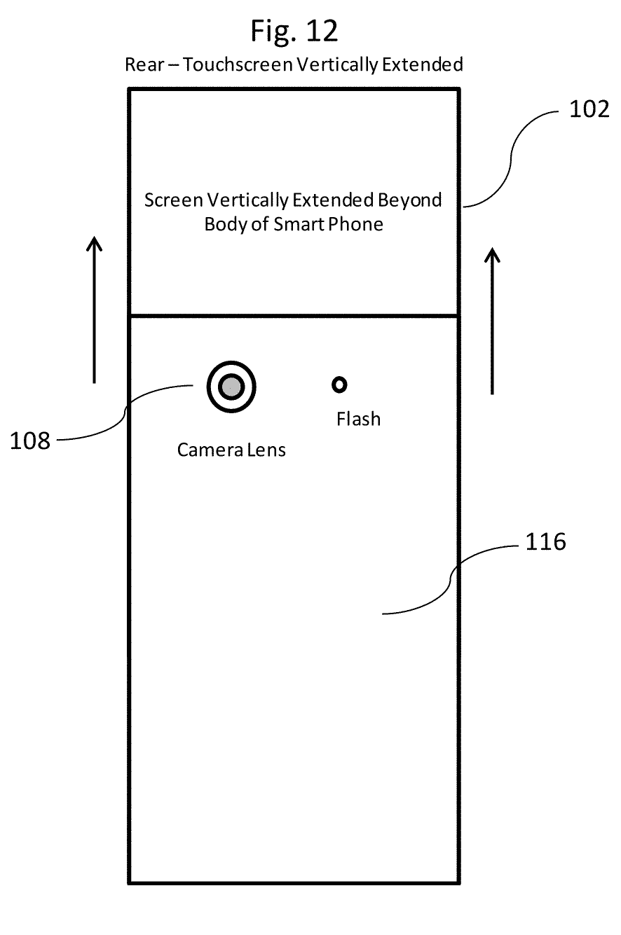

FIG. 12 shows a rear view of the illustrative smart phone of FIG. 11 with the touchscreen 102 vertically extended to reveal the underneath physical QWERTY keyboard (e.g., not visible in this view). The touchscreen 102 extends past the body of smart phone 116 that houses the physical QWERTY keyboard.

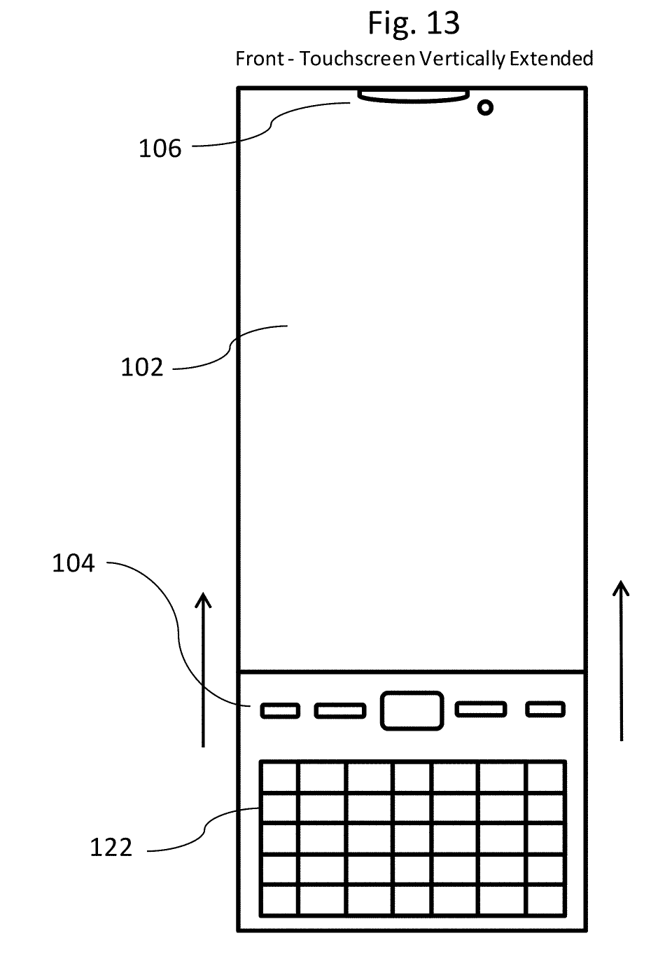

FIG. 13 shows a front view of an illustrative smart phone as shown in FIGS. 3-4 with the touchscreen vertically slid to reveal the physical QWERTY keyboard 122 and a mouse/trackpad and other buttons 104. In this embodiment, in contrast to FIG. 11, the buttons and track pad 104 are not incorporated in the top “infinity” touchscreen layer 102. Rather, like the physical QWERTY keyboard 122, the track pad and buttons 104 are only exposed when the touchscreen is vertically extended. This allows for a larger, very sleek infinity touchscreen to be the only thing that is outward-facing and seen when the device is in an un-extended state.

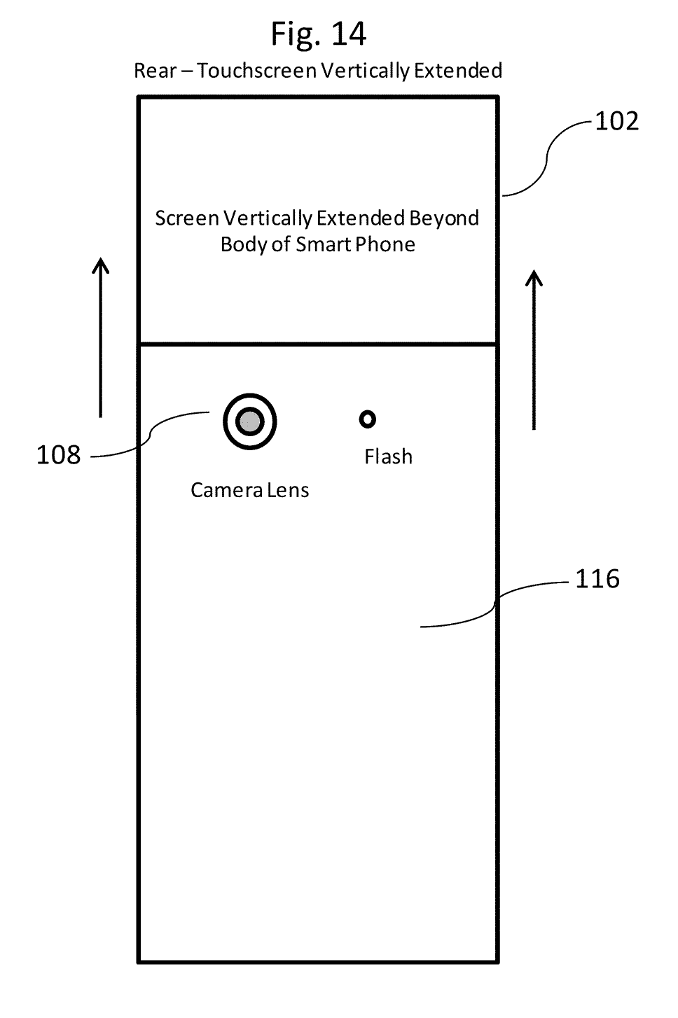

FIG. 14 shows the back view of the illustrative phone of FIG. 13 with the touchscreen 102 extended. Element 108 shows the outward-facing camera and flash. Element 116 shows the body of the device and the layer that houses the physical keyboard

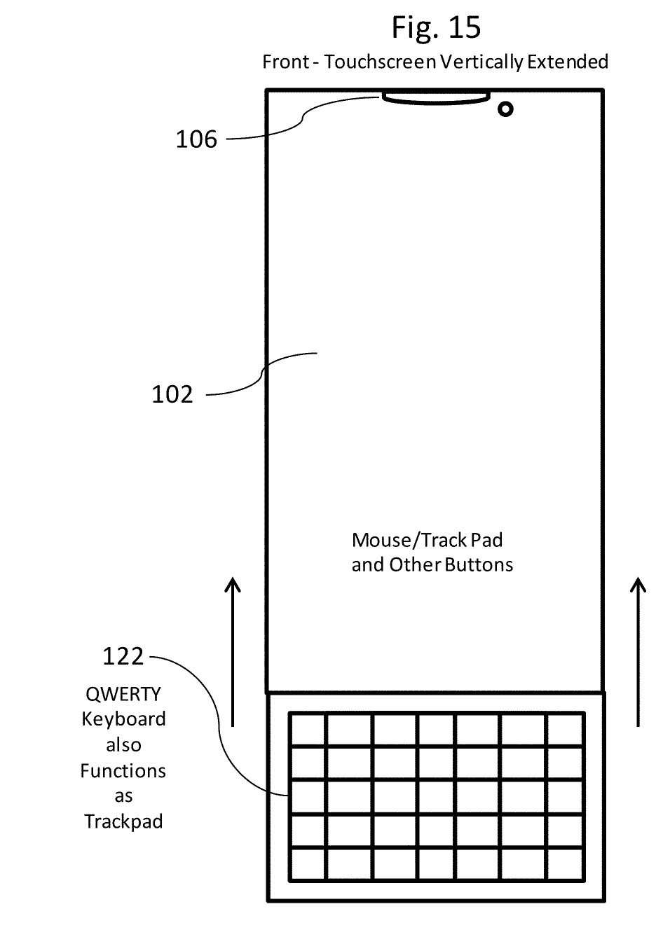

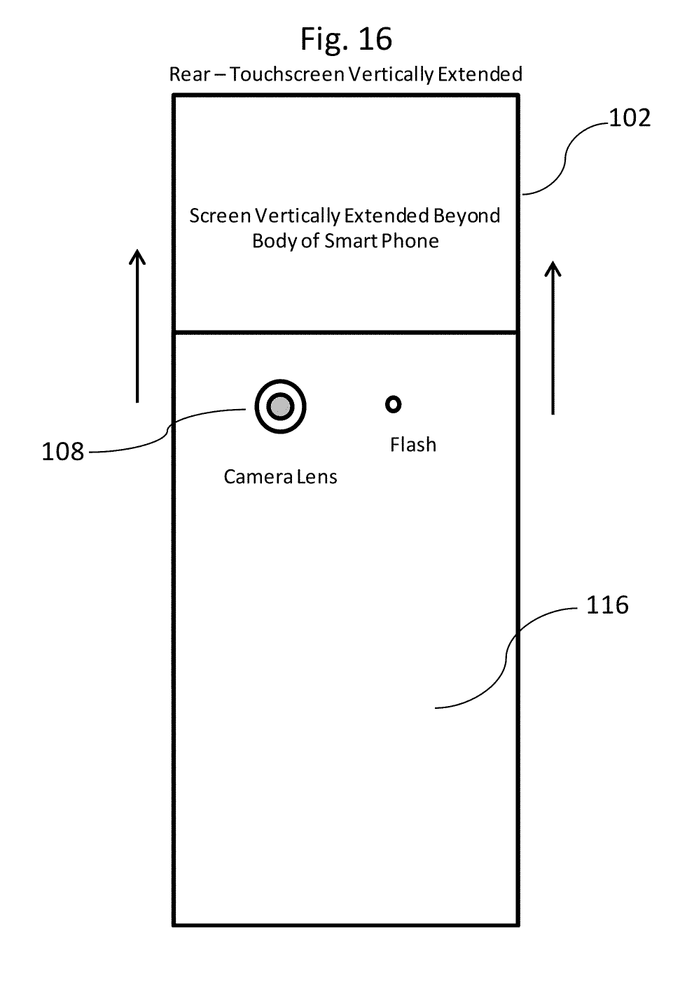

FIG. 15 shows a front view of an illustrative smart phone as shown in FIGS. 3-4 with the infinity touchscreen 102 extended and the physical QWERTY keyboard 122 exposed. In this embodiment, there is not a physical mouse, track pad, or other buttons as have been shown as 104. Instead, the physical keyboard 122 functions as a virtual trackpad when that functionality is required. FIG. 16 is the back view of the illustrative smart phone of FIG. 15 with the touchscreen 102 extended.

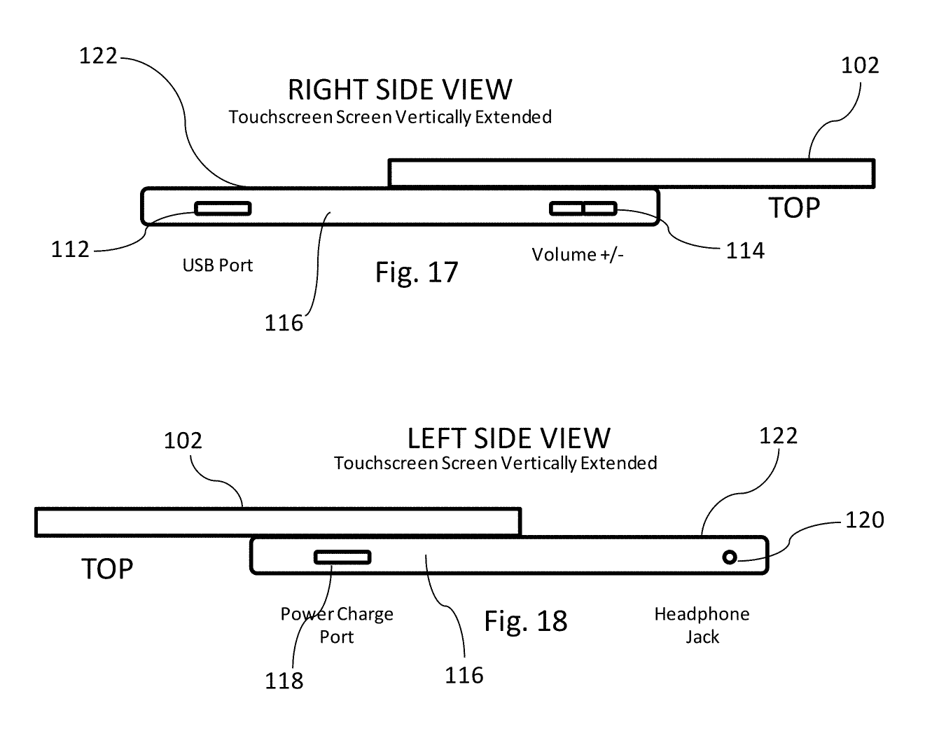

FIGS. 17-18 shows right and left side views of an illustrative smart phone as shown in FIGS. 1-4 with the touchscreen 102 vertically extended to reveal the underneath physical QWERTY keyboard 122 (e.g., which is positionally-highlighted but not visible from this view), as well as illustrate the various layers of the device. Element 116 shows the second layer of the illustrative smart phone that houses the physical keyboard 122, as well as being able to include other aspects, such as the battery, processor, memory, track pad, other buttons, and the like. The USB port 112 and volume control 114 are shown in FIG. 17. The power charge port 118 and the headphone jack 120 are shown in FIG. 18. Side buttons and other ports and controls are there for illustration only and could be included on the other side, the top or bottom of the illustrative smart phone, or elsewhere, as will be appreciated by those of ordinary skill in the relevant art(s).

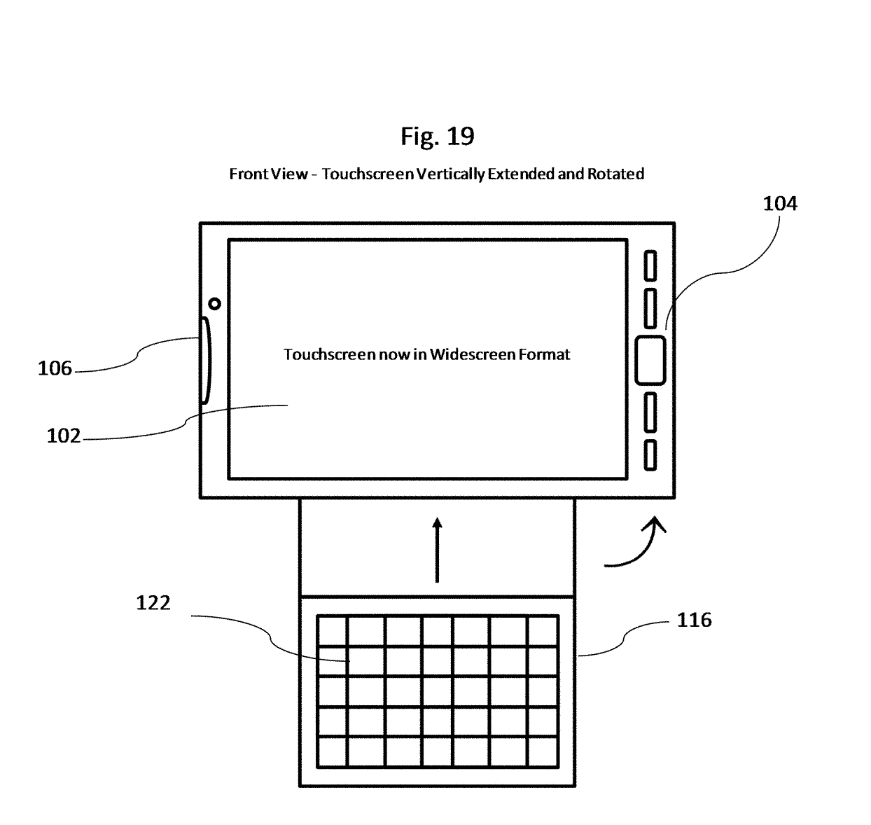

FIG. 19 shows a front view of an illustrative smart phone as shown in FIGS. 1-2 and FIGS. 11-12 with the touchscreen 102 vertically extended to reveal the physical QWERTY keyboard 122 and then rotated 90 degrees to take advantage of the widescreen format so that the entire device resembles the letter “T.” This is an advantageous attribute of the present invention, as it allows for the combination of a physical QWERTY keyboard and a horizontal widescreen format touchscreen. Typically, this compelling combination was only available in a desk top setup, a full laptop computer, or a tablet with a separately purchased and connected physical keyboard—all of which traditionally are considered higher productivity tools than a smart phone. For those who consider themselves writers and prefer the physical QWERTY keyboard, their productivity would be far greater with the current invention than when working on a touchscreen-only smart phone—as they now have the benefit of the physical keyboard and a horizontal widescreen screen. Documents can now be viewed and edited horizontally—more like a regular computer monitor—which allows for more words per line and likely better composing and editing. The benefit of this combination is also striking when viewing and working with large drawings and other applications. In this embodiment, as the mouse/track pad and other buttons 104 are part of the touchscreen layer, they are seen on what is now the right hand side of the rotated screen. In this position, they are not convenient for typing with the physical QWERTY keyboard. Accordingly, in this embodiment, their functionality could be minimized, modified, or completely altered when the touchscreen is 90-degrees rotated. Element 106 shows a speaker and front-facing “selfie” camera. Element 116 shows the body of the device that houses the physical QWERTY keyboard.

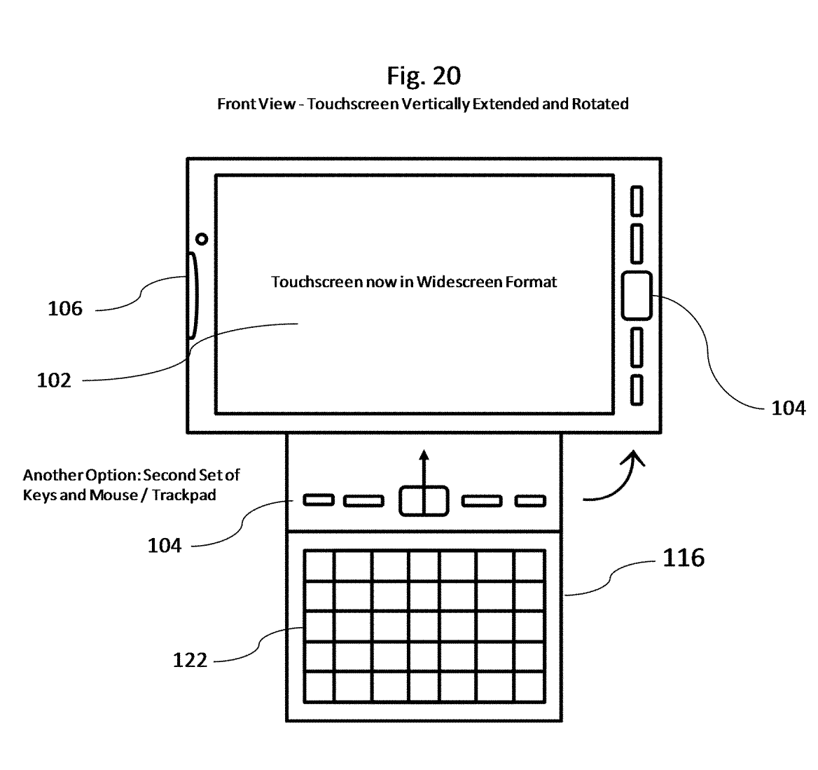

FIG. 20 shows a front view of an illustrative smart phone, as shown in FIGS. 1-2 and 11-12 with the touchscreen 102 vertically extended to reveal the physical QWERTY keyboard 122 and then rotated 90 degrees to take advantage of the widescreen format, so that the entire device resembles the letter “T.” In this embodiment, a second set of buttons and trackpads 104 is revealed when the touchscreen is swiveled for continued comfortable access to these buttons, features, and functionality when the screen is now in widescreen format.

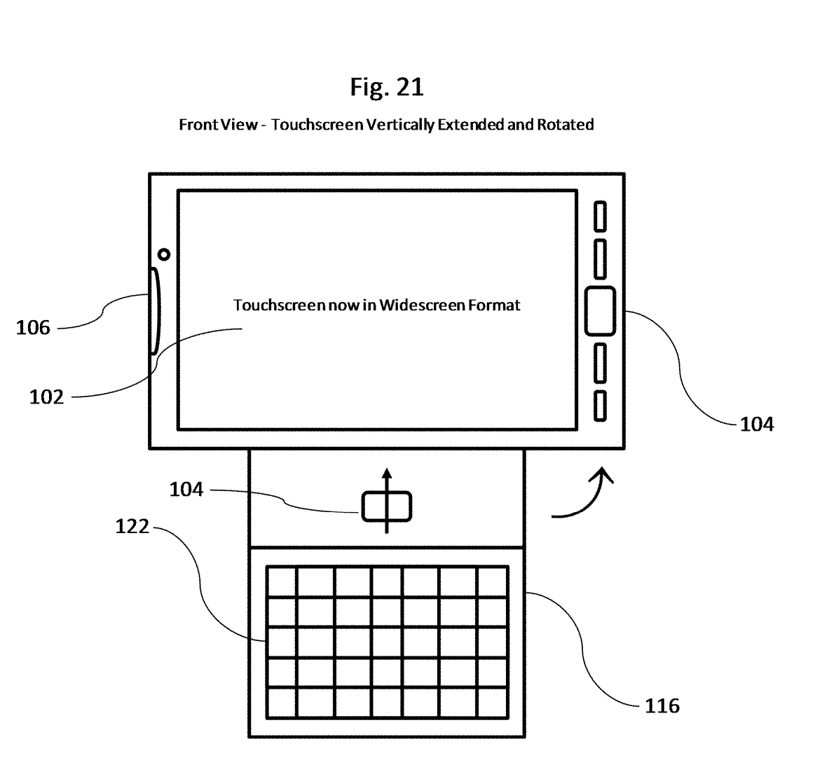

FIG. 21 shows a front view of an illustrative smart phone, as shown in FIGS. 1-2 and 11-12, with the touchscreen 102 vertically extended to reveal the physical QWERTY keyboard 122 and then rotated 90 degrees to take advantage of the widescreen format so that the entire device resembles the letter “T.” In this embodiment, there is not a full second set of buttons 104 when the touchscreen is rotated 90 degrees, and only a secondary trackpad is represented in the second set 104.

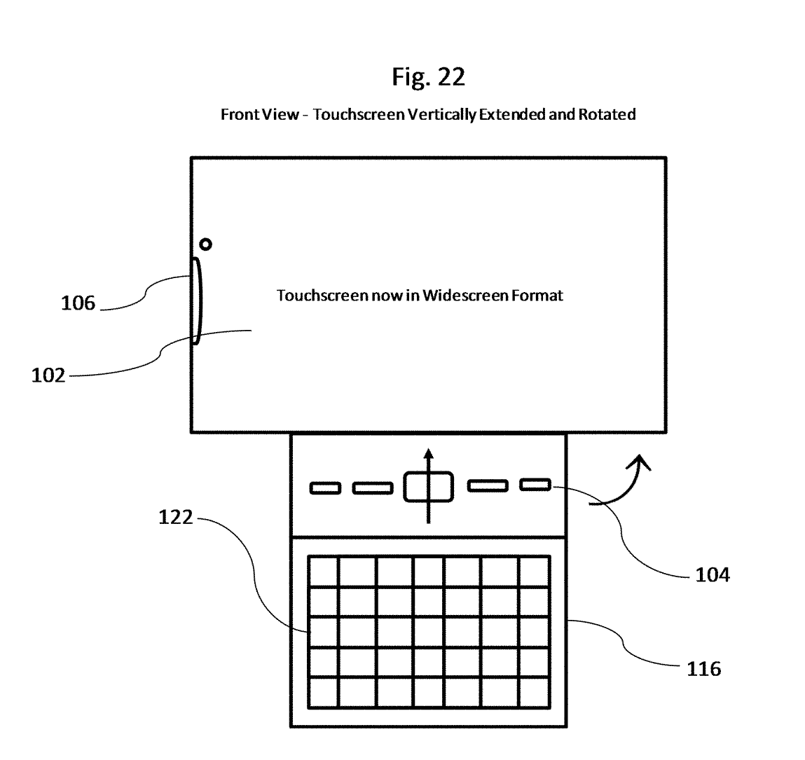

FIG. 22 shows a front view of an illustrative smart phone, as shown in FIGS. 3-4 with the “infinity” touchscreen 102 both vertically slid to reveal the physical QWERTY keyboard 122 and then rotated 90 degrees to have the widescreen format, so that the entire device resembles the letter “T.” In this embodiment, while the physical QWERTY keyboard is exposed when the screen is vertically slid, the track pad and buttons 104 are only exposed after the screen is rotated 90 degrees. This allows the layer with the touchscreen 102 to be elegantly “infinity” and unencumbered by any buttons. Moreover, this configuration maximizes the advantages of the rotational touchscreen by exposing the track pad and buttons 104, when touchscreen 102 is rotated 90 degrees to widescreen format. The additional room exposed that is utilized for 104 in this embodiment, would not be available on the base layer 116, absent the ability of touchscreen 102 to rotate. Advantageously, the space occupied by 104 typically is not accessible in other smart phone designs. This enables the device to provide a higher level of productivity, as in this position, distinct advantages are provided: (i) the physical QWERTY keyboard 122 is exposed; (ii) the touchscreen 102 is rotated and in widescreen format for better viewing, reading, and editing; and (iii) there is additional space for functional buttons, a trackpad, and the like 104.

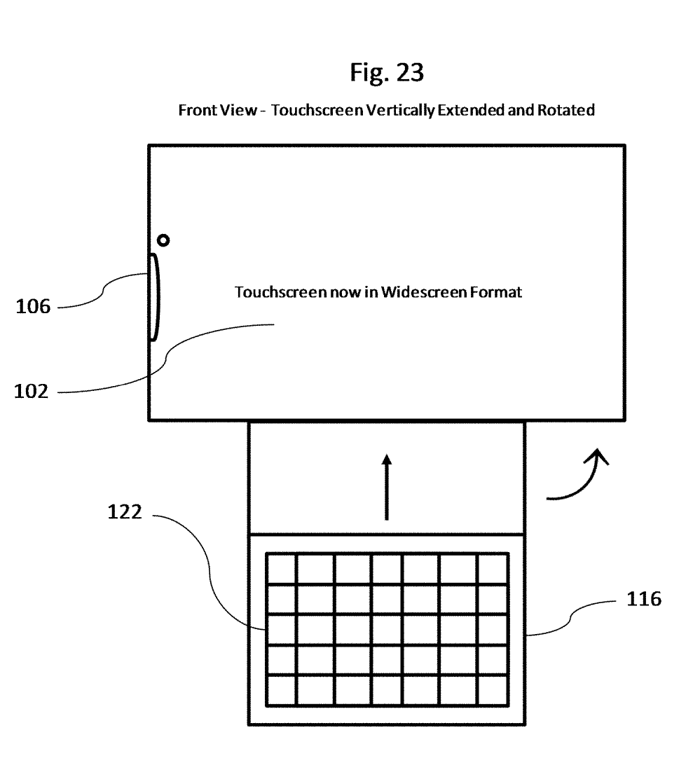

FIG. 23 shows a front view of an illustrative smart phone, as shown in FIGS. 3-4 with the “infinity” touchscreen 102 both vertically slid to reveal the physical QWERTY keyboard 122 and then rotated to take advantage of the widescreen format, so that the entire device resembles the letter “T.” In this embodiment, there is no trackpad or other physical buttons. Rather, the QWERTY keyboard 122 can also function as the track pad. Element 106 denotes the speaker and the front-facing selfie camera, and element 116 denotes the body of layer with the physical QWERTY keyboard. By contrast, available touchscreen-only smart phones do not have a physical QWERTY keyboard. Similarly, vertical slide phones that do have a keyboard, typically force the user to work in a portrait/vertical screen mode, wherein a user cannot ever see a full line of text. The ability to rotate the screen to work in conjunction with the physical QWERTY keyboard enables a significant productivity boost. Moreover, if a user is viewing video in this position, advantageously: (i) the device is much easier to support and hold for long durations in the palm of the hand; and (ii) video can be viewed naturally in widescreen format.

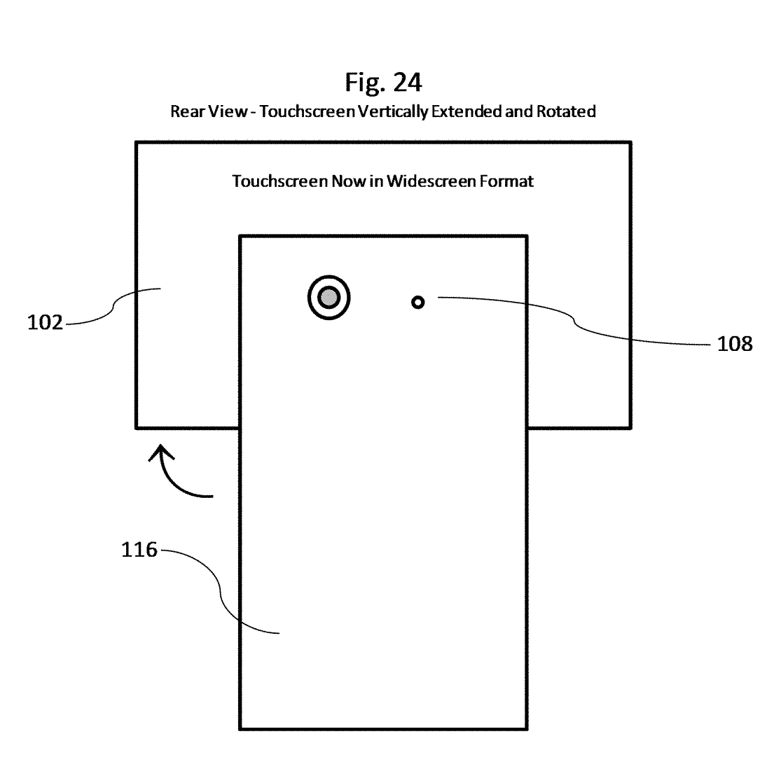

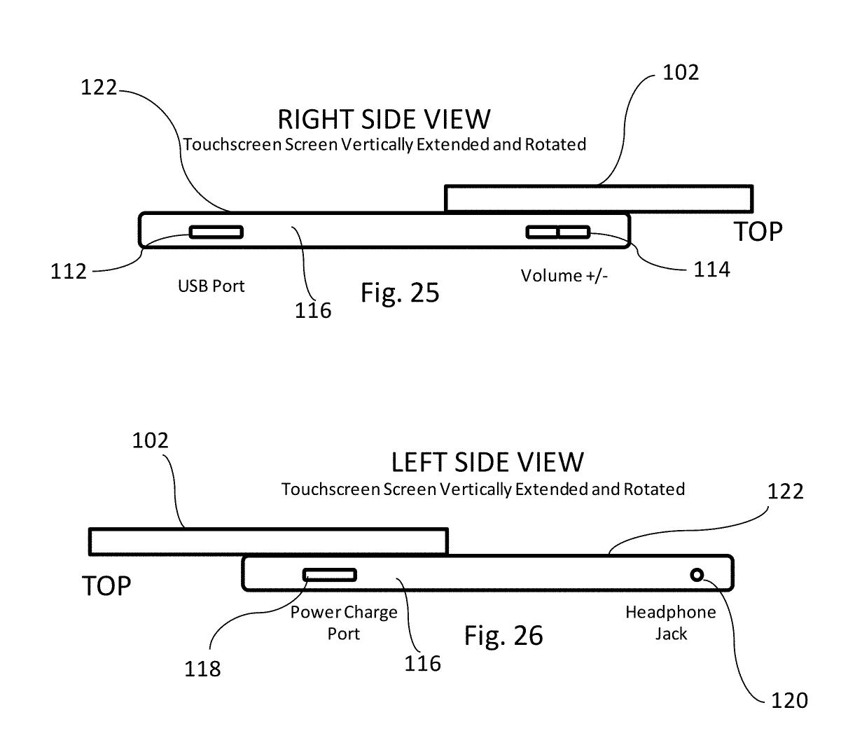

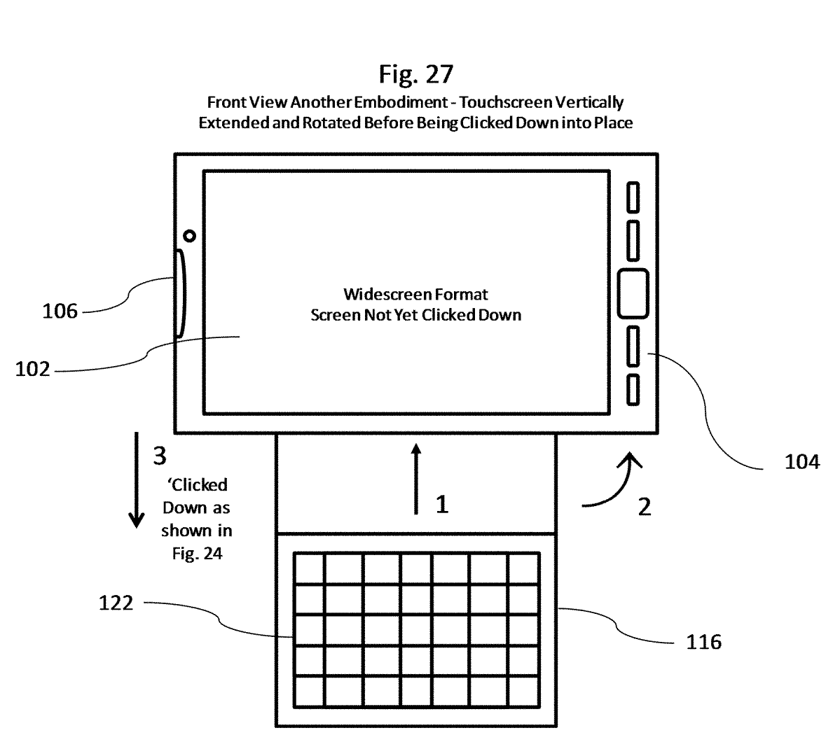

FIG. 24 shows a rear view of an illustrative smart phone with the touchscreen 102 both vertically slid to reveal the physical QWERTY keyboard and then rotated to take advantage of the widescreen format, so that the entire device resembles the letter “T.” Element 108 shows the camera and flash, and element 116 shows the body of the layer that houses the physical QWERTY keyboard.

FIGS. 25-26 illustrate right and left side views of an illustrative smart phone, as shown in FIGS. 1-4, with the touchscreen 102 both vertically slid to reveal the physical QWERTY keyboard and then rotated to take advantage of the widescreen format. Element 116 shows the body/second layer of the device that houses the physical QWERTY keyboard. While it is not visible in this side view, element 122 illustrates where the physical QWERTY keyboard is located. In FIG. 25, element 112 denotes a USB port and element 114 denotes volume controls. Both 112 and 114 can be located in various different locations, as is clear to those familiar in the art. In FIG. 26, 118 shows a power charge port, and 120 shows a headphone jack. Elements 118 and 120 can be located in various different locations, as will be appreciated by those skilled in the relevant art(s).

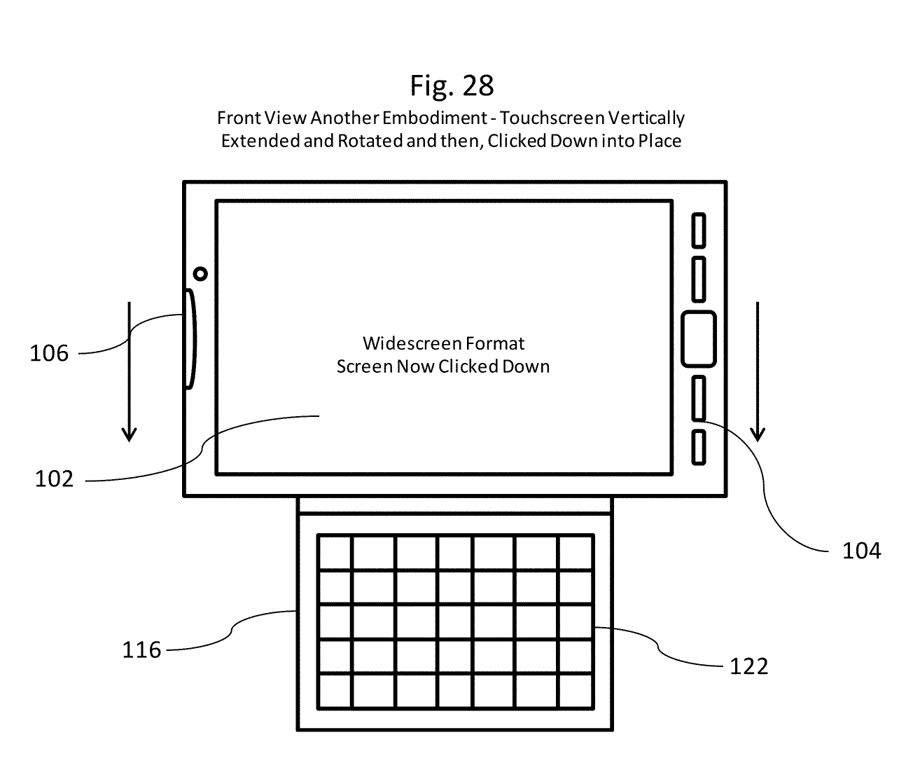

FIG. 27 shows another front view of an illustrative smart phone with the touchscreen 102 vertically slid to reveal the physical QWERTY keyboard 122 and then rotated counter-clockwise 90 degrees to take advantage of the widescreen format, so that the entire device resembles the letter “T.” Speaker and selfie camera 106 now appear on the left side versus the center because of the 90-degree rotation. Likewise, buttons and track pad 104 are on the right side versus the center because of the 90-degree rotation. Of course, the touchscreen layer can also be made to rotate clockwise instead of counter-clockwise in which case 106 can be on the right side and 104 on the left, as will be appreciated by those skilled in the relevant art(s). In this embodiment, the widescreen screen clicks (e.g., via a suitable detent, latching mechanism, etc.) downward after rotation for a slightly more compact experience, as shown in FIG. 28.

FIG. 28 shows a front view of the illustrative smart phone shown in FIG. 27 with its touchscreen 102 being clicked down into place after having been extended and rotated 90 degrees, as first shown in FIG. 19. Advantageously, clicking the rotated screen downward reduces the overall size/area of the device, making for a more compact experience. The clicking into place can also contribute to a more durable design.

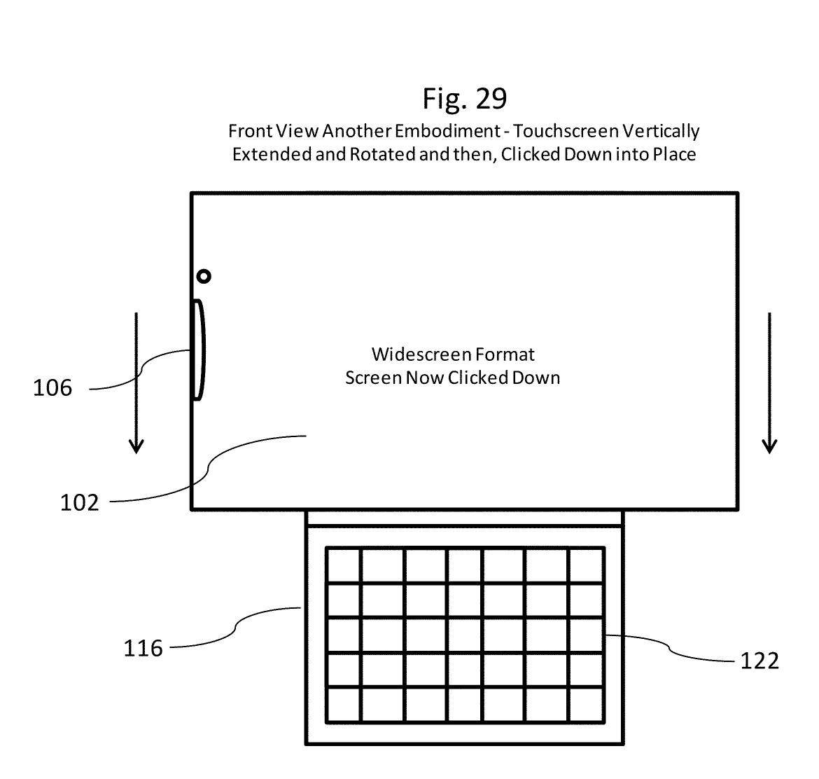

FIG. 29 shows another front view example of an illustrative smart phone as shown in FIG. 23 with the “infinity” touchscreen 102 clicked downward, after having already been vertically slid to reveal the physical QWERTY keyboard 122, and then rotated 90 degrees to take advantage of the widescreen format so that the entire device resembles the letter “T.” This makes for a more compact and ergonomically comfortable experience (e.g., when relaxing and watching a movie or other video), as a user only need support the lower portion of the body layer 116 in the palm of the hand. Presently, most every smart phone necessitates being physically turned and held horizontally to get the full benefit of the widescreen. However, it is very cumbersome to hold a smart phone in this horizontal position for any duration of time. In fact, most people have difficulty supporting a horizontal smart phone for even short periods of time. Moreover, not only does this invention allow a user to support the device in the palm of the hand, but also, with the touchscreen 102 now 90 degrees rotated so that it forms the top of the “T,” the device can rest above the thumb and forefinger alleviating the need to even apply additional pressure to hold the device making this invention that much more comfortable for longer-term viewing.

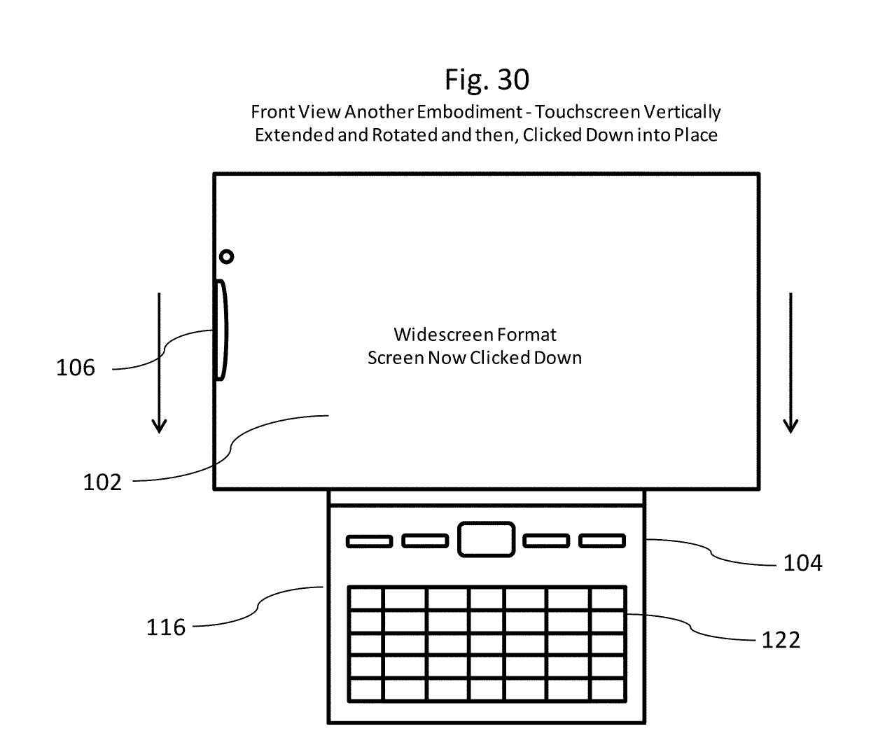

FIG. 30 shows the rotated, and clicked-into-place widescreen embodiment of FIG. 29, but with the trackpad and other buttons 104 in addition to the physical keyboard 122 as part of the body layer 116.

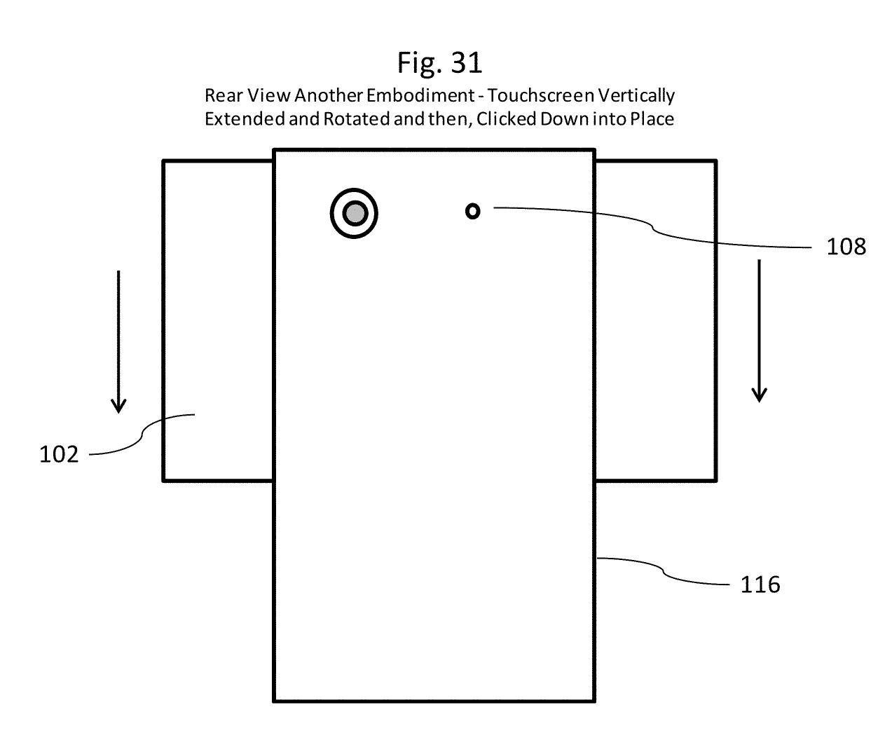

FIG. 31 shows a rear view of the embodiment shown in FIGS. 28-30, wherein the touchscreen 102 has been vertically slid to reveal the physical QWERTY keyboard, rotated to take advantage of the widescreen format, so that the entire device resembles the letter “T”, and then clicked downward after 90-degree rotation for a slightly more compact experience. Conveniently, the position of the outward facing camera and flash 108 can stay centered, as they are located in the body/second layer 116 that houses the physical QWERTY keyboard.

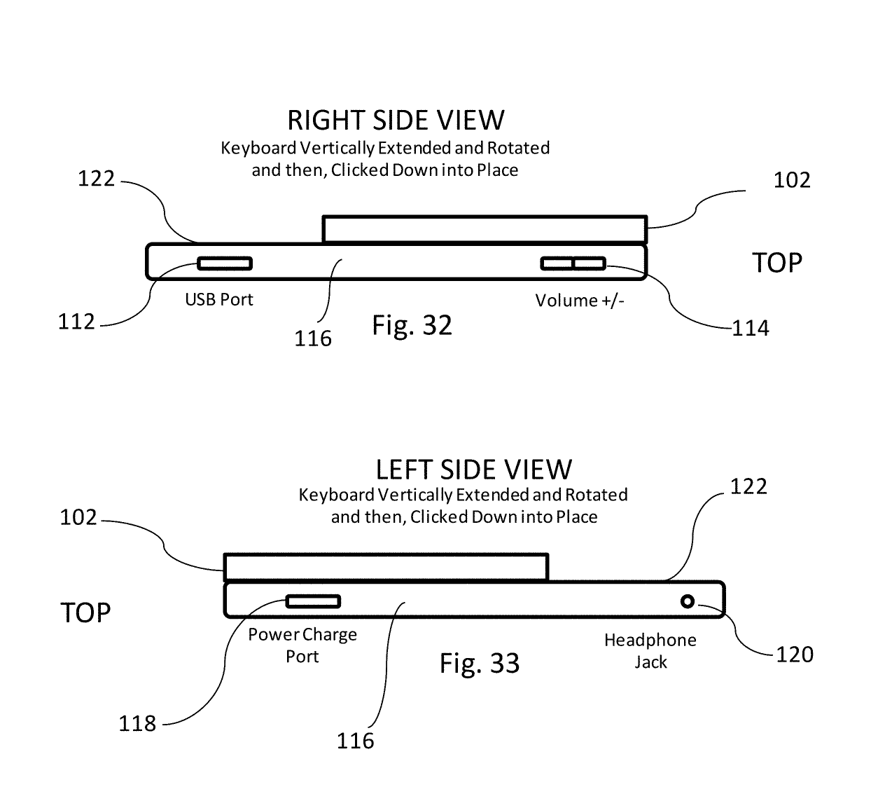

FIGS. 32-33 illustrate right and left side views of an illustrative smart phone as shown in FIGS. 28-31 with the touchscreen layer 102 clicked downward into place after rotation for a slightly more compact experience. The touchscreen 102 no longer overhangs the body 116 on the top, as is the case when not clicked down, as shown in FIGS. 25-26. This embodiment can contribute to better ergonomic comfort, for example, when handling the device, as well as providing durability in use. While not directly visible, the location of the physical QWERTY keyboard is indicated by 122. The USB port 112 and volume controls 114 are shown in FIG. 32, and the power charge port 118 and headphone jack 120 shown in FIG. 33. All of these could be located on different sides, as well as on the top, bottom, or elsewhere, as will be appreciated by those skilled in the relevant art(s).

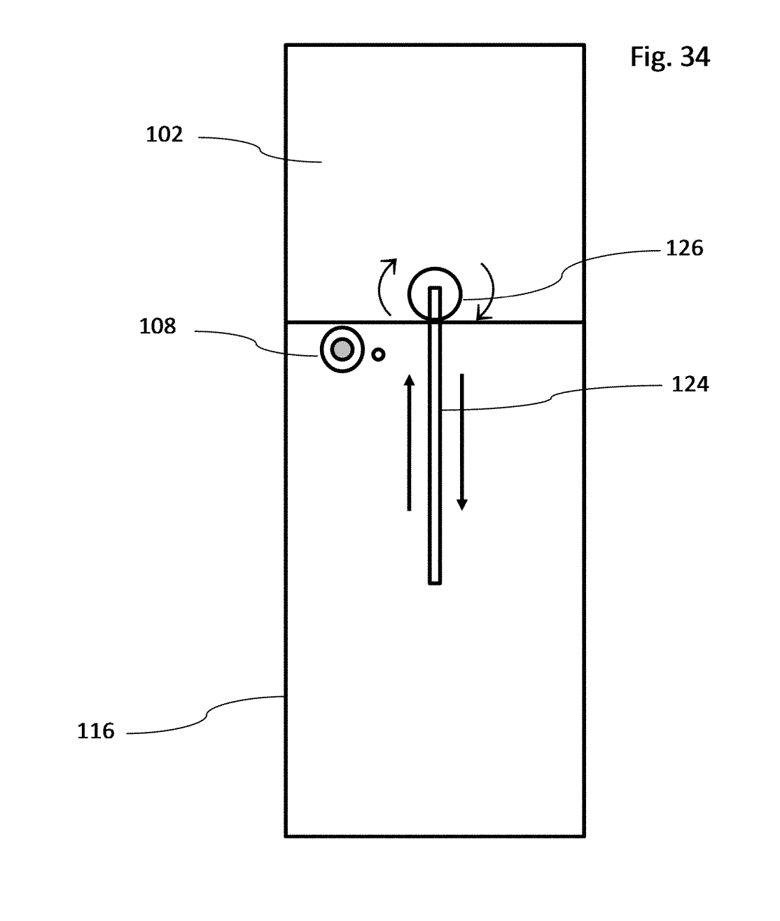

FIG. 34 shows a back view of the conceptual internals of an illustrative smart phone revealing the vertical extension of the touchscreen 102 along vertical track 124 just prior to its rotation on rotary connector washer mount 126. Element 116 shows the body of the smart phone that houses the physical QWERTY keyboard (not visible), and 108 shows the outward facing camera and flash.

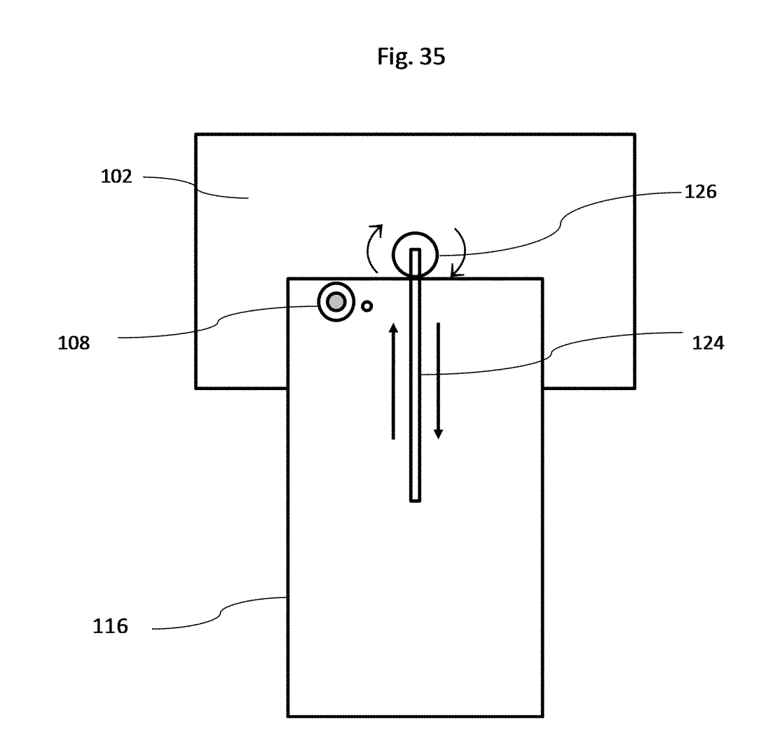

FIG. 35 shows the back view of the internals of FIG. 24 after the touchscreen 102 has been rotated 90 degrees on rotary connector washer mount 126.

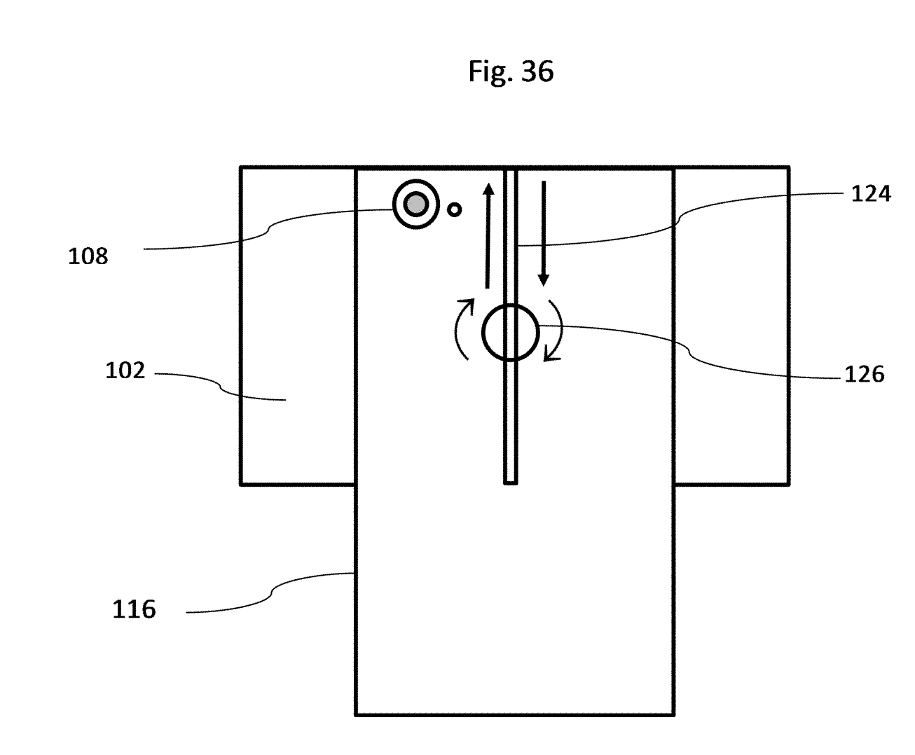

FIG. 36 shows the back view of the internals of FIGS. 34-35 with the further feature of the touchscreen 102 being clicked down into place after vertical extension and rotation as shown in FIG. 31 for a slightly more compact experience.

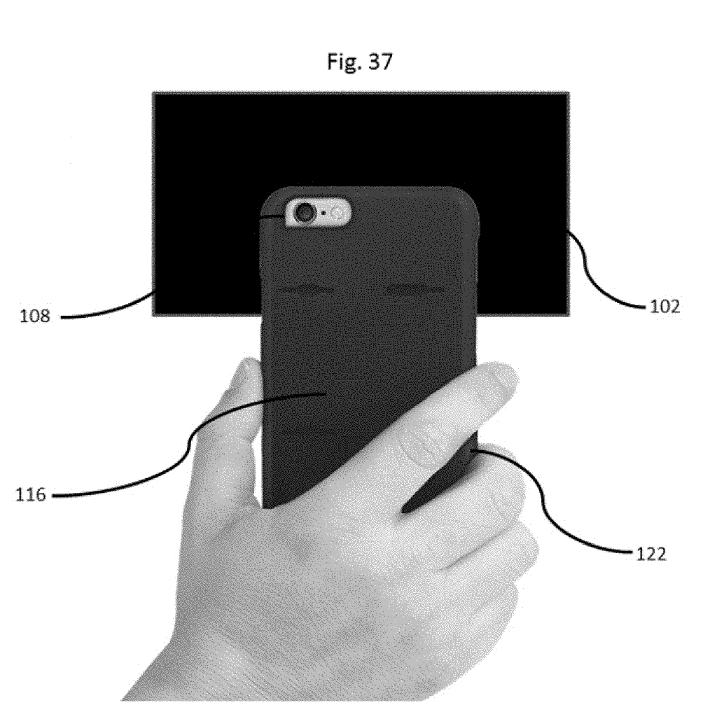

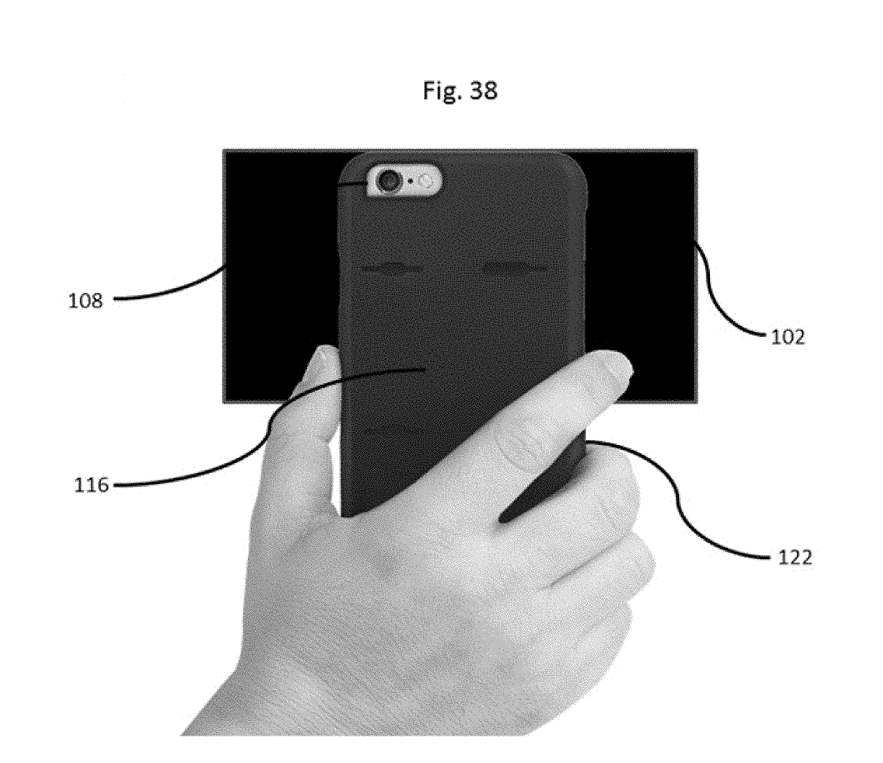

FIG. 37 shows a back view of the embodiment as seen in FIG. 24 and FIG. 35, and highlights how, because of the invention's more pragmatic ergonomic design, a hand is able to comfortably hold the illustrative smart phone in the palm with the invention's rotated screen in widescreen format for better viewing. FIG. 38 shows a back view of the embodiment as seen in FIG. 31, and highlights how, in comparison to FIG. 37, the click down embodiment contributes to a more compact experience. The blending of the enormous productivity increases capable with a widescreen format, the ability to watch videos in the same format as you would on your desktop PC or laptop, and the far superior comfort and ergonomics, of course in conjunction with the physical QWERTY keyboard (which is not visible but indicated by 122) provides the above and numerous other advantages over conventional smart phone designs.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present invention has been described in connection with a number of illustrative embodiments and implementations, the present invention is not so limited but rather covers various modifications and equivalent arrangements, which fall within the purview of the appended claims.

1. A smart phone, comprising:
a body layer of a smart phone that houses a physical QWERTY keyboard and including a single vertical track; and
a touchscreen layer of the smart phone housing a touchscreen and configured above the body layer and including a rotary connector movably coupled to the single vertical track of the body layer,
wherein the touchscreen layer slides along the single vertical track over the body layer to reveal the physical QWERTY keyboard, and
the touchscreen layer then rotates via the rotary connector over the body layer to form a symmetrical T-shape with the body layer to allow viewing of and interacting with content in a widescreen format on the touchscreen, while also allowing use of the physical QWERTY keyboard.

2. The smart phone of claim 1, wherein the rotated touchscreen clicks downward into a locked position.

3. The smart phone of claim 1, wherein the sliding and rotating touchscreen includes a trackpad and buttons.

4. The smart phone of claim 1, wherein the sliding and rotating touchscreen is configured as an infinity screen.

5. The smart phone of claim 1, wherein when the touchscreen is not slid and not rotated, the smart phone appears and functions as a touchscreen-only smart phone.
